(19) United States
(12) Patent Application Publication
(10) Pub. No.: US 2026/0132748 A1
(43) Pub. Date: May 14, 2026

(54) METHOD FOR DEFINING CYLINDER TORQUE DEMAND DURING TRANSITIONS IN SKIP-FIRE ENGINE OPERATION

(71) Applicant: DAF Trucks N.V., Eindhoven (NL)

(72) Inventor: Luc Hubertus Josephina Worms, Eindhoven (NL)

(21) Appl. No.: 19/311,734

(22) Filed: Aug. 27, 2025

(30) Foreign Application Priority Data
Aug. 27, 2024 (NL) 2038503

(51) Int. Cl. F02D 17/02; F02D 1/02

(52) U.S. Cl. CPC F02D 17/02; F02D 1/02; F02D 2200/1006; F02D 2250/21

(57) ABSTRACT

A method for defining cylinder torque demand during transitions in skip-fire engine operation of a combustion engine having a number N of cylinders, the method comprising: firing the engine in first cycles of a first pattern of N events, that defines for each cylinder of the engine a fire or skip fire event in one cycle of the first cycles, with a first fuel quantity for each fire event in the first cycle; transitioning the engine to firing the engine in second cycles of a second pattern of N events of fire and skip fire events for each cylinder, with a second fuel quantity for each fire event in the second cycle; carrying out one or more transitioning fire events, in transitioning from the first to the second pattern, with a dynamic fuel quantity, to compensate for torque loss of a preceding or succeeding skip fire event of said fire event, wherein the adjustment differs from the first and/or second fuel quantity.

### FIELD OF INVENTION

The invention relates to a method for defining cylinder torque demand during transitions in skip-fire engine operation of a combustion engine having a number N of cylinders.

### DESCRIPTION OF THE PRIOR ART

New technologies are required to meet the increasingly stringent emission and fuel consumption legislation for internal fuel combustion engines. In some of the latest advances no fuel is injected in some of the cylinders, leading to a higher efficiency and cylinder torque demand on the remaining active cylinders. One example is an asymmetric injection operation, where the fuel injection on some cylinders is stopped, while the valve operation of all cylinders continues. The main advantage is that the higher cylinder torque demand leads to a higher fuel quantity to be injected per cylinder. This makes it easier to use a series of late post injections to create a higher exhaust gas temperature to keep warm the SCR in the aftertreatment system. If coupled with an asymmetric EGR path connected to a single engine bank, it could also lead to higher exhaust gas temperatures without using late post injections, by only injecting fuel in the non-EGR part of the engine. Another example is cylinder deactivation operation (CDA), where both the fuel injection and the valve operation of some cylinders is stopped. This leads to higher exhaust gas temperatures and a decreased exhaust flow, ideal for keeping the SCR warm. In addition, CDA leads to fuel consumption benefits due to the decreased pumping losses.

One of the main problems coupled to skip-fire engine operation such as asymmetric injection or cylinder deactivation, is that it leads to additional noise, vibration, harshness (NVH). Running a less-than-maximum amount of active cylinders is shown to increase the NVH.

The present invention aims to further reduce strong torque fluctuations in the transition for a cylinder from active to inactive.

### SUMMARY OF THE INVENTION

It is an object to increase the smoothness of transitions when a cylinder is activated or deactivated.

To this end a method is proposed according to the features of claim 1. In particular the invention relates to a method for defining cylinder torque demand during transitions in skip-fire engine operation of a combustion engine having a number N of cylinders, the method comprising:
firing the engine in first cycles of a first pattern of N events, that defines for each cylinder of the engine a fire or skip fire event in one cycle of the first cycles, with a first fuel quantity for each fire event in the first cycle;
transitioning the engine to firing the engine in second cycles of a second pattern of N events of fire and skip fire events for each cylinder, with a second fuel quantity for each fire event in the second cycle; and
carrying out one or more transitioning fire events, in transitioning from the first to the second pattern, with a dynamic fuel quantity, to compensate for torque loss of a preceding or succeeding skip fire event of said fire event, wherein the adjustment differs from the first and/or second fuel quantity.

In other words, instead of immediately adjusting a fuel injection for a second cycle, in a transitioning phase from the first to the second pattern the fuel injection is adjusted. This leads to a smoother transition, wherein NVH effects are diminished.

### BRIEF DESCRIPTION OF THE DRAWINGS

The invention will be further elucidated in the figures:

FIG. 1 shows a transient response for a six cylinder engine transitioning from all cylinders firing to three skip fires;

FIG. 2 shows a dynamically adjusted transient response for the six cylinder engine example of FIG. 1;

FIG. 3 shows a schematic flow diagram to illustrate the inventive method;

FIG. 4 shows a further example of a transient response when changing the order of firing while keeping the number of firing constant.

### DETAILED DESCRIPTION

Unless otherwise defined, all terms (including technical and scientific terms) used herein have the same meaning as commonly understood by one of ordinary skill in the art to which this disclosure belongs as read in the context of the description and drawings. It will be further understood that terms, such as those defined in commonly used dictionaries, should be interpreted as having a meaning that is consistent with their meaning in the context of the relevant art and will not be interpreted in an idealized or overly formal sense unless expressly so defined herein. In some instances, detailed descriptions of well-known devices and methods may be omitted so as not to obscure the description of the present systems and methods. Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be further understood that the terms “comprises” and/or “comprising” specify the presence of stated features but do not preclude the presence or addition of one or more other features.

While example embodiments are shown for systems and methods, also alternative ways may be envisaged by those skilled in the art having the benefit of the present disclosure for achieving a similar function and result. E.g. some components may be combined or split up into one or more alternative components. Finally, these embodiments are intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the scope of the present systems as set forth in the claims that follow. The specification and drawings are accordingly to be regarded in an illustrative manner and are not intended to limit the scope of the appended claims.

Any reference signs in the claims do not limit their scope; several “means” may be represented by the same or different item(s) or implemented structure or function; any of the disclosed devices or portions thereof may be combined together or separated into further portions unless specifically stated otherwise. The mere fact that certain measures are recited in mutually different claims does not indicate that a combination of these measures cannot be used to advantage.

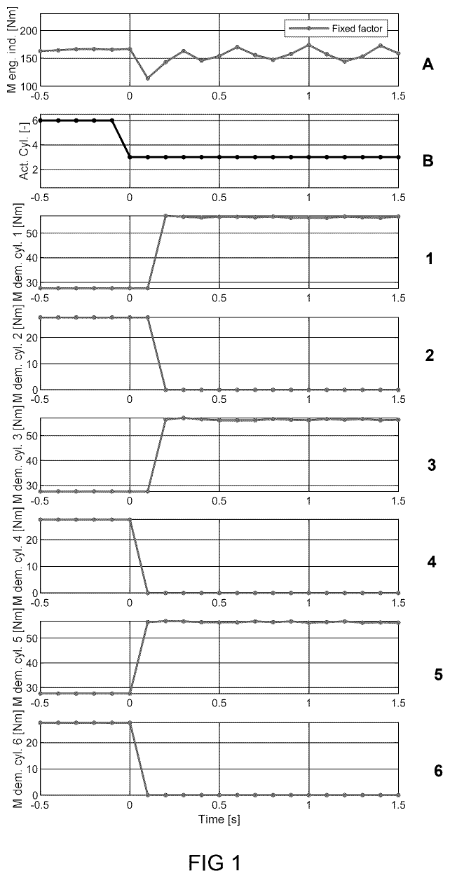

Turning to FIG. 1, there is illustrated a transient response (A) for a six cylinder engine, that switches on t=0 from 6 to 3 cylinders (B), while maintaining a substantially constant torque of about 170 Nm. It can be shown in the torque diagram A that before t=0 there is a smooth and constant torque, which changes massively in the transient phase (about 50 Nm), and then restores to about 170 Nm but with more variation in torque. Diagrams 1-6 show respective torque responses for cylinders 1-6, where it can be shown that cylinder 1, 3 and 5 increase in torque (about twice) to account for the higher torque/cylinder demand in order to produce a substantially equal engine torque after the switch on t=0. Similarly, cylinders 2, 4 and 6 do not produce any net torque.

To account for a ‘fixed factor’ constant torque, the cylinder torque needs to be adjusted according to

$${T}_{cyl} = \frac{{T}_{eng}}{{n}_{cyl . tot}} \cdot \frac{{n}_{cyl . tot}}{{n}_{cyl . act}} = \frac{{T}_{eng}}{{n}_{cyl . act}}$$

Thus, for instance, when three cylinders remain active, after switching, cylinders individually will increase a torque according to 6/3, and will thus double. In principle this scales similarly with the fuel quantity demand for a cylinder, which will amount to a doubled increase of fuel for the active cylinders in this case.

In more detail, by way of a numerical example, the following table analyses the transition, when a torque of 170 Nm is requested at a fixed factor, in terms of an actual torque which is calculated as the sum of six previous cylinder torque values.

TABLE 1
Fixed factor 6→3 cylinders transition

| 6 → 3 active cylinders | | | Fixed factor | | |
|---|---|---|---|---|---|
| | Indicated | | | | Actual |
| | eng. | Fire | | Cyl. | indicated |
| | torque | (1)/ | | torque | engine |
| Time | dem. | skip | Act. | dem. | torque |
| [s] | [Nm] | (0) | cyl. | [Nm] | [Nm] |
| 0 | 170 | 1 | 6 | 28.3 | 170 |
| 0.02 | 170 | 1 | 6 | 28.3 | 170 |
| 0.04 | 170 | 1 | 6 | 28.3 | 170 |
| 0.06 | 170 | 1 | 6 | 28.3 | 170 |
| 0.08 | 170 | 1 | 6 | 28.3 | 170 |
| 0.10 | 170 | 1 | 6 | 28.3 | 170 |
| 0.12 | 170 | 0 | 3 | 0 | 141.7 |
| 0.14 | 170 | 1 | 3 | 56.7 | 170 |
| 0.16 | 170 | 0 | 3 | 0 | 141.7 |
| 0.18 | 170 | 1 | 3 | 56.7 | 170 |
| 0.20 | 170 | 0 | 3 | 0 | 141.7 |
| 0.22 | 170 | 1 | 3 | 56.7 | 170 |
| 0.24 | 170 | 0 | 3 | 0 | 170 |
| 0.26 | 170 | 1 | 3 | 56.7 | 170 |

It is shown that the individual torque, in the example increases from 28.3 to 57.7 (doubling, as discussed) in the firing cycle, after t=0.10. However, while this will provide a substantial constant torque after the transition, the sum during transition fluctuates as the first skip fire is ‘not accounted for’ and will produce a torque loss (from 170 to 141.7). The first subsequent fire (t=0.14) will restore this, to the original value, but it will drop again after the second skip (t=0.16) and so on, until the transition is complete by completing an entire fire cycle over all cylinders.

According to the inventive principle, the torque demand is, instead of switched by a nominal fixed factor accounting for a steady state afterwards, switched by a dynamic factor during the transient operation, i.e. the first entire cycle of subsequent firing/skip operations for all engine cylinders.

Table 2 shows the same example as table 1, but now with the dynamic factor added. 1 cylinder torque is increased from 28 to 43 Nm. This leads to an engine torque that is 14 Nm higher in 3 instances, and 14 Nm lower in 3 instances. On average this gives an engine torque of exactly 170 Nm.

TABLE 2
Fixed and dynamic factor 6→3 cylinders transition

| 6 → 3 active cylinders | | | Fixed factor | | | Dynamic factor | | |
|---|---|---|---|---|---|---|---|---|
| | Indicated | | | | Actual | | | Actual |
| | eng. | Fire | | Cyl. | indicated | | Cyl. | indicated |
| | torque | (1)/ | | torque | engine | Surrounding | torque | engine |
| Time | dem. | skip | Act. | dem. | torque | skips/ | dem. | torque |
| [s] | [Nm] | (0) | cyl. | [Nm] | [Nm] | 2 + 1 | [Nm] | [Nm] |
| 0 | 170 | 1 | 6 | 28.3 | 170 | 1 | 28.3 | 170 |
| 0.02 | 170 | 1 | 6 | 28.3 | 170 | 1 | 28.3 | 170 |
| 0.04 | 170 | 1 | 6 | 28.3 | 170 | 1 | 28.3 | 170 |
| 0.06 | 170 | 1 | 6 | 28.3 | 170 | 1 | 28.3 | 170 |
| 0.08 | 170 | 1 | 6 | 28.3 | 170 | 1 | 28.3 | 170 |
| 0.10 | 170 | 1 | 6 | 28.3 | 170 | 1.5 | 42.5 | 184.2 |
| 0.12 | 170 | 0 | 3 | 0 | 141.7 | 0 | 0 | 155.8 |
| 0.14 | 170 | 1 | 3 | 56.7 | 170 | 2 | 56.7 | 184.2 |
| 0.16 | 170 | 0 | 3 | 0 | 141.7 | 0 | 0 | 155.8 |
| 0.18 | 170 | 1 | 3 | 56.7 | 170 | 2 | 56.7 | 184.2 |
| 0.20 | 170 | 0 | 3 | 0 | 141.7 | 0 | 0 | 155.8 |
| 0.22 | 170 | 1 | 3 | 56.7 | 170 | 2 | 56.7 | 170 |
| 0.24 | 170 | 0 | 3 | 0 | 170 | 0 | 0 | 170 |
| 0.26 | 170 | 1 | 3 | 56.7 | 170 | 2 | 56.7 | 170 |

From the table it becomes clear that the actual engine torque per cylinder, when using the dynamic factor, is different during the first six transient fire cycles, starting with firing the preceding cylinder before the switch at t=0.10. This accounts for a total torque that is kept more constant, i.e. by supplying the amount of fuel necessary to keep the torque, as a sum of six (depending on the amount of cylinders active on the engine) previous values, substantially constant. For example, dynamical fuel quantity adjustment can be carried out to keep the sum of torques of N preceding events substantially constant, for each succeeding fire event in the transitioning cycle.

This can be done by adjusting the amount of fuel or requested torque by including additional torque in an active fire event, during the transition, of torque expected at that fire event itself, plus half of the torque expected during the previous skips, plus half of the torque expected during the upcoming skips. Accordingly, the method can be executed with a dynamic fuel quantity for each transitioning fire event being equal to half of the torque missed by a directly preceding skip fire event and half of the torque missed by a directly succeeding skip fire event. Or, in equation form:

$${T}_{cyl} = \frac{{T}_{eng}}{{n}_{cyl . tot}} \cdot ( \frac{{n}_{skips , prev .}}{2} + 1 + \frac{{n}_{skips , next .}}{2} )$$

During steady state running, this equation gives the same results as the fixed factor equation. To give an example, if the engine is having 3 out of 6 cylinders active, there is 1 skip before and 1 skip after each fire event. Cylinder torque is then ½+1+½=2 times as high as during 6 cylinder running, the same as 6/3=2. However, during transitions in amount of active cylinders, this method adjusts the cylinder torque demand (and thus the fueling) of up to 2 firing events. This method is referred to as ‘dynamic factor’.

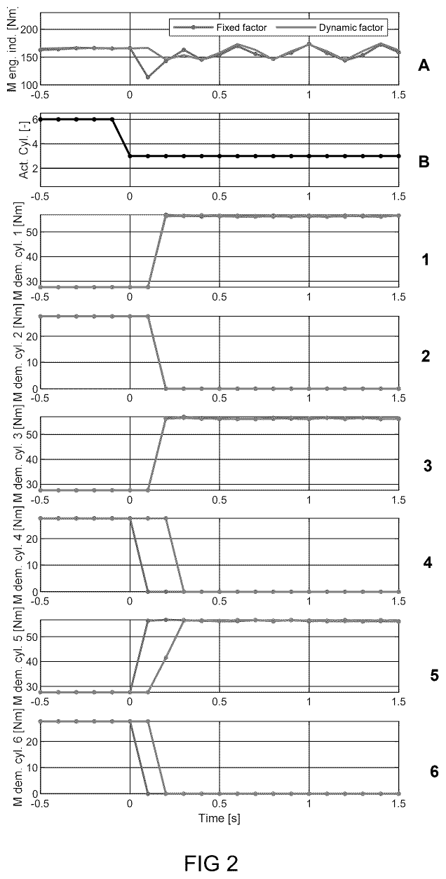

FIG. 2 shows the corresponding dynamic transient response (A) for a six cylinder engine, that switches on t=0 from 6 to 3 cylinders (B), while maintaining a substantially constant torque of about 170 Nm with a dynamic factor included. It can be shown in the torque diagram A that before t=0 there is a smooth and constant torque, which now changes less dramatically in the transient phase, and about immediately restores to about 170 Nm but with more variation in torque, which continues after the transient. Diagrams 1-6 show respective torque responses for cylinders 1-6, where it can be shown that cylinder 1, 3 and 5 increase in torque (about twice) to account for the higher torque/cylinder demand in order to produce a substantially equal engine torque after the switch on t=0. Similarly, cylinders 2, 4 and 6 do not produce any net torque after the transient, but cylinders 4 and 6 are kept at a higher torque initially, and cylinder 5 at a lower torque initially.

The dynamic transient response not only helps to reduce torque oscillations in transitions between different amount of active cylinders, but also in transitions between different active cylinders.

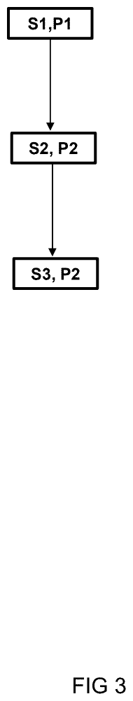

In FIG. 3 there is shown a schematic progression of the torque control in a method for defining cylinder torque demand during transitions in skip-fire engine operation of a combustion engine having a number N of cylinders as illustrated:

In Step S1 the engine is fired in first cycles of N events of a first pattern P1, that defines for each cylinder of the engine a fire or skip fire event, with a first fuel quantity for

each fire event in the first cycle. In Step S2 the engine is fired in a transitioning cycle, wherein the cycle is preferably a complete cycles of N events or less;

In Step S3 the engine is transitioned to firing the engine in second cycles of a second pattern of N events of fire and skip fire events for each cylinder, with a second fuel quantity for each fire event in the second cycle. The inventive principle lies in step S2 as an intermediate step, where one or more transitioning fire events are carried out, in transitioning from the first to the second pattern, with a dynamic fuel quantity, to compensate for torque loss of a preceding or succeeding skip fire event of said fire event, wherein the adjustment differs from the first and/or second fuel quantity.

As shown in FIG. 2, the transitioning may be a single cycle, i.e. of a maximum of N events, but depending on the dynamic adjustment, it may be more than N events or cycles of N events.

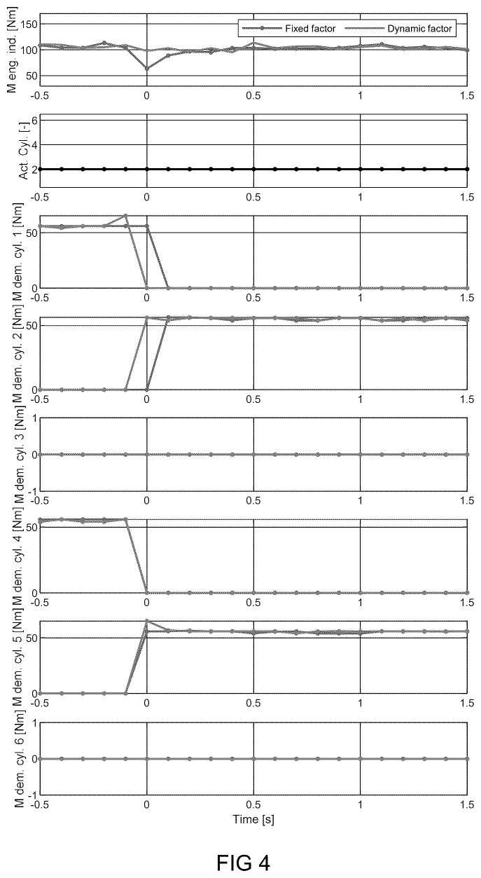

FIG. 4 shows a further example of a transient response when changing the order of firing while keeping the number of firing cylinders constant, in the example for a two cylinder running engine. Thus, while the preceding was illustrated with the second fuel quantity is different from the first fuel quantity to keep the engine at a constant torque, alternatively, the method can be executed without changing the numbers of cylinders firing, but changing the order, for example to address NVH effects. Two cylinder running on a six cylinder engine leads to a repeating pattern of one fire and two skips. In the example, during two cylinder running, a transition can be done from firing cylinder 1 (t=0) and 4 (t=0.06) to cylinder 5 (t=0.20) and 2 (t=0.26). In the example, an additional skip is inserted to change the pair of active cylinders. When using a fixed factor, the cylinder torque demand remains constant (because the amount of active cylinders remains constant) but the additional skip leads to a dip in engine torque. When using the new dynamic factor, the torque demand at the fire events before and after the 3-skip-sequence is increased slightly to account for the additional skip.

TABLE 3
Fixed and dynamic factor engine torque during 2 cylinder
running, with a change in active cylinders

| 2 active cylinders → switch | | | Fixed factor | | | Dynamic factor | | |
|---|---|---|---|---|---|---|---|---|
| | Indicated | | | | Actual | | | Actual |
| | eng. | Fire | | Cyl. | indicated | | Cyl. | indicated |
| | torque | (1)/ | | torque | engine | Surrounding | torque | engine |
| Time | dem. | skip | Act. | dem. | torque | skips/ | dem. | torque |
| [s] | [Nm] | (0) | cyl. | [Nm] | [Nm] | 2 + 1 | [Nm] | [Nm] |
| 0 | 110 | 1 | 2 | 55 | 110 | 3 | 55 | 110 |
| 0.02 | 110 | 0 | 2 | 0 | 110 | 0 | 0 | 110 |
| 0.04 | 110 | 0 | 2 | 0 | 110 | 0 | 0 | 110 |
| 0.06 | 110 | 1 | 2 | 55 | 110 | 3 | 55 | 110 |
| 0.08 | 110 | 0 | 2 | 0 | 110 | 0 | 0 | 110 |
| 0.10 | 110 | 0 | 2 | 0 | 110 | 0 | 0 | 110 |
| 0.12 | 110 | 1 | 2 | 55 | 110 | 3.5 | 64.2 | 119.2 |
| 0.14 | 110 | 0 | 2 | 0 | 110 | 0 | 0 | 119.2 |
| 0.16 | 110 | 0 | 2 | 0 | 110 | 0 | 0 | 119.2 |
| 0.18 | 110 | 0 | 2 | 0 | 55 | 0 | 0 | 64.2 |
| 0.20 | 110 | 1 | 2 | 55 | 110 | 3.5 | 64.2 | 128.3 |
| 0.22 | 110 | 0 | 2 | 0 | 110 | 0 | 0 | 128.3 |
| 0.24 | 110 | 0 | 2 | 0 | 55 | 0 | 0 | 64.2 |
| 0.26 | 110 | 1 | 2 | 55 | 110 | 3 | 55 | 119.2 |
| 0.28 | 110 | 0 | 2 | 0 | 110 | 0 | 0 | 119.2 |
| 0.3 | 110 | 0 | 2 | 0 | 110 | 0 | 0 | 119.2 |
| 0.32 | 110 | 1 | 2 | 55 | 110 | 3 | 55 | 110 |

Additional logic may be added to provide robustness when transitioning in-an out of 0 cylinder operation. In such a case, the amount of skips before or after a fire event can be very high, leading to extremely high fuel demands to compensate for this high amount of skips. To avoid this, the fixed factor is used if the amount of skips before or after the fire event is higher than the amount of cylinders on the engine.

1. A method for defining cylinder torque demand during transitions in skip-fire engine operation of a combustion engine having a number N of cylinders, the method comprising:
firing the engine in first cycles of a first pattern of N events, that defines for each cylinder of the engine a fire or skip fire event, with a first fuel quantity for each fire event in the first cycle;
transitioning the engine to firing the engine in second cycles of a second pattern of N events of fire and skip fire events for each cylinder, with a second fuel quantity for each fire event in the second cycle; and
carrying out one or more transitioning fire events, in transitioning from the first to the second pattern, with a dynamic fuel quantity, to compensate for torque loss of a preceding or succeeding skip fire event of said fire event, wherein the adjustment differs from the first and/or second fuel quantity.

2. The method according to claim 1, wherein the transitioning fire event is carried out in a transition cycle between first and second cycles.

3. The method according to claim 2, wherein the transition cycle comprises a maximum of N events.

4. The method according to claim 1, wherein the dynamic fuel quantity for each transitioning fire event is equal to half of the torque missed by a directly preceding skip fire event and half of the torque missed by a directly succeeding skip fire event.

5. The method according to claim 1, wherein the second pattern has a different number of firing cylinders than the first pattern.

6. The method according to claim 1, wherein the second fuel quantity is different from the first fuel quantity to keep the engine at a constant torque.

7. The method according to claim 1, wherein the dynamical fuel quantity adjustment is carried out to keep the sum of torques of N preceding events substantially constant.

8. The method according to claim 1, wherein the engine is a six cylinder diesel engine of a commercial vehicle.
